(19) United States
(12) Patent Application Publication
(10) Pub. No.: US 2025/0004521 A1
(43) Pub. Date: Jan. 2, 2025

(54) TIMING AND POWER MODELING IN FLEXMBFF COMPILERS

(71) Applicant: Synopsys, Inc., Sunnyvale, CA (US)

(72) Inventors: Deepak Dattatraya SHERLEKAR, Cupertino, CA (US); Ravi Vithal NAVI, Bengaluru (IN); Basannagouda Somanath REDDY, San Jose, CA (US); Aditya SONI, Bangalore (IN)

(21) Appl. No.: 18/215,663

(22) Filed: Jun. 28, 2023

(51) Int. Cl. G06F 1/28; G06F 1/10

(52) U.S. Cl. CPC G06F 1/28; G06F 1/10

(57) ABSTRACT

Characterizing one or more flip-flop bits includes obtaining first load capacitances associated with a first flip-flop bit of a multi-bit flip-flop family coupled with a control block, and obtaining second load capacitances associated with a second flip-flop bit of the multi-bit flip-flop family coupled with the control block. The method further combining the first load capacitances with the second load capacitances to generate combined load capacitances. Further, the method includes determining, by a processing device, at least one selected from the group comprising a delay parameter for the first flip-flop bit and a constraint parameter for the first flip-flop bit based on the combined load capacitance.

### TECHNICAL FIELD

The present disclosure relates to modeling the timing and power characteristics of multi-bit flip-flops.

### BACKGROUND

A multi-bit flip-flop includes multiple flip-flops (each corresponding to a bit of memory) and generally uses less space on a chip or board than an equivalent number of single-bit flip-flops. Further, using multi-bit flip-flops reduces power within the corresponding circuit devices. A flip-flop is a clock-controlled memory device used to store an input state, and in response to the clock signal, output the stored state as a bit having a binary value. A single-bit flip-flop stores one bit of information, whereas a multi-bit flip-flop stores multiple bits of information. Flip-flops come in several varieties, including D flip-flops, T flip-flops, and JK flip-flops, of which any of one can be combined into a multi-bit flip-flop. The process of modelling the physical and electrical characteristics of these multi-bit flip-flops is called characterization. The characterized models are used during chip implementation to determine the timing and power behavior of every instance of the multi-bit flip-flop.

### SUMMARY

In one example, a method includes obtaining first load capacitances associated with a first flip-flop bit of a multi-bit flip-flop family coupled with a control block, and obtaining second load capacitances associated with a second flip-flop bit of the multi-bit flip-flop family coupled with the control block. The method further combining the first load capacitances with the second load capacitances to generate combined load capacitances. Further, the method includes determining, by a processing device, at least one selected from the group comprising a delay parameter for the first flip-flop bit and a constraint parameter for the first flip-flop bit based on the combined load capacitance.

In one example, a method includes determining, via a processing device, a characterization of a first flip-flop bit of a multi-bit flip-flop family based on a characterization model comprising a control block and the first flip-flop bit. Outputs of the control block are coupled to inputs of the first flip-flop bit. Determining the characterization of the first flip-flop bit comprises determining at least one selected from a group comprising a delay parameter for the first flip-flop bit and a constraint parameter for the first flip-flop bit based on a load capacitance associated with the first flip-flop bit and a second flip-flop bit of the multi-bit flip-flop family. The method further comprises updating a database of flip-flop bit models based on the characterization of the first flip-flop bit.

In one example, a method includes obtaining timing parameters of one or more input pins of a flip-flop bit, and obtaining transition rates and arrival times associated with the one or more input pins of the flip-flop bit based on the timing parameters. Further, the method includes determining a skew rate between two pins of the one or more input pins of the flip-flop bit based on a difference between corresponding arrival times of the two pins. The method further includes determining at least one selected from the group comprising a delay parameter for the flip-flop bit and a constraint parameter for the flip-flop bit based on the transition rates, the arrival times, and the skew rate.

In one example, a method includes determining, via a processing device, a characterization of a first flip-flop bit based on a characterization model comprising the first flip-flop bit and based on at least one selected from the group comprising a delay parameter the first flip-flop bit and a constraint parameter of the first flip-flop bit. The method further includes updating a database of flip-flop bit models based on the characterization of the first flip-flop bit.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a block diagram of an example multi-bit flip-flop.

FIG. 2 illustrates a block diagram of an example multi-bit flip-flop.

FIG. 3 illustrates a block diagram of an example multi-bit flip-flop.

FIG. 4 illustrates a block diagram of an example multi-bit flip-flop.

FIG. 5 illustrates a block diagram of an example flip-flop bit characterization model.

FIG. 6 illustrates a block diagram of an example flip-flop bit characterization model.

FIG. 7 depicts a lookup table for the wire load-capacitance for modelling a flip-flop bit based on characterization model of FIG. 5.

FIG. 8 depicts a flowchart of a method for modeling flip flop bit based on characterization model of FIG. 5.

FIG. 9 depicts a flowchart of a method for modeling flip flop bit based on characterization model of FIG. 6.

FIG. 10 depicts a flowchart of a method for modeling and characterizing a multi-bit flip flop.

FIG. 11 depicts a flowchart of various processes used during the design and manufacture of an integrated circuit in accordance with some embodiments of the present disclosure.

FIG. 12 depicts a diagram of an example computer system in which embodiments of the present disclosure may operate.

### DETAILED DESCRIPTION

Aspects of the present disclosure relate to timing and power modeling of flexible multi-bit flip-flops. Multi-bit flip-flops (MBFFs) are design concepts used to reduce power within the circuit designs. Fixed or “pre-built” MBFFs defined in logic libraries (or databases) may be pre-built elements. For example, an MBFF are modeled and constructed as a single macro cell. In such an example, the components of the MBFF are fully defined in both circuit schematic and layout.

Using pre-built MBFFs reduces choice in improving chip level design. For example, consider a library having three drive strengths per cell on a semiconductor process with seven different voltage threshold (VT) transistor devices. For a given circuit topology and bit-count, this library will have MBFFs of three drive strengths per VT, or a total of twenty-one different MBFFs.

In one or more examples, FlexMBFFs may be used instead of pre-built MBFFs. FlexMBFFs enable on-the-fly assembly of a very large number of unique MBFFs from a small number of building blocks. In one example, a FlexMBFF is an MBFF family that can be constructed from a specified list of flip-flop bits or a specified set of flip-flop bits and a common control block or blocks. The number of unique MBFFs grows super exponentially in the number of bits. As used herein, “on-the-fly” assembly is contrasted against monolithic assembly so that elements of an MBFF “on-the-fly” can be selected and/or adjusted to suit design parameters, as compared to selecting a pre-built MBFF as a single monolithic element from a library. In one or more examples, the use of FlexMBFFs permits construction of MBFFs with any specified bit-count, further improving upon current libraries which provide only a subset of bit counts—for example, 2, 4, 8, and 16.

The number of unique MBFFs in FlexMBFF increases exponentially with bit count. Accordingly, modeling and characterizing each MBFF in a FlexMBFF family is computationally expensive due to the large number of possible MBFFs. In the following, two compact timing and power models of FlexMBFFs and their characterization methods are described. These FlexMBFF models can be used to generate timing and power models of MBFFs in the FlexMBFF family. The compact FlexMBFF models enable on-the-fly extraction of the timing and power model of any MBFF in the FlexMBFF family without explicitly enumerating and modeling each MBFF individually. The compact timing and power models are used to describe the behavior of a flip-flop bit in an MBFF in a FlexMBFF family.

As is described in further details in the following, a model for a FlexMBFF is characterized by simulating circuits that are similar to those of conventional MBFFs. The unique formulation of the models enables the characterization process described herein that uses less computational power and increases the efficiency of the characterization.

In one or more examples, using a FlexMBFF during a chip implementation process permits incrementally changing an existing MBFF by adding or removing one or more flip-flop bits, modifying one or more flip-flop bits, or modifying the control block, without completely dismantling the MBFF. In an MBFF in a FlexMBFF family, a control block that contains the control circuitry is connected to one or more flip-flop bits. Accordingly, individual flip-flop bits can be altered without affecting the layout of other flip-flop bits or control circuitry. Further, the control circuity can be altered without affecting the layout of the flip-flop bits. Finally, the MBFF resulting from the changes is also a member of the FlexMBFF family, since it is made up of FF bits and control blocks that belong to the FlexMBFF. Hence, the timing and power model of the resulting MBFF can be extracted from the FlexMBFF timing and power model. As used herein, a flip-flop bit generally refers to circuitry (or a representation of circuitry) used to implement a single-bit flip-flop without the control circuitry.

A FlexMBFF control block (e.g., a shared logic block) contains circuit elements shared between flip-flops and used to drive bits (e.g., a digital node) in the MBFF. These bits may include a clock (CK) node, a complement clock (CK′) node, scan-enable (SE) node, and complement SE (SE′) node.

There are other optional implementations for the control block. For example, the control block may contain delay elements (e.g., a clock delay block or an integrated clock gating block configured to selectively disable at least one clock signal for at least one of the plurality of flip-flops) in the clock path to enable injection of useful clock signal skew. The control block may also contain an integrated clock gating logic that may be used to gate the flop bits in the MBFF. In other embodiments, the control block can implement non-critical scan enable buffers using low power (higher VT) devices and may have a lower drive strength as compared to a clock signal. In some implementations, the control block may be split into two cells, one to implement a clock splitter and one to handle scan enable. In another example, the control block may be included in other MBFF topologies that result in additional or different shared signals being implemented in the control block, such as the conditional clock generation for flip-flops with scan enable described.

A bit-slice block of an MBFF of a FlexMBFF family (otherwise called an FF bit) can be understood as a single bit flip-flop that has been stripped of its scan enable and clock buffers. These buffers may be migrated to a FlexMBFF control block (e.g., control block) described below. A bit-slice block contains the data and scan enable input of the flip-flop, plus inputs to receive CK, CK′ and SE′ inputs from the control block. The bit-slice block has an output (Q output) and/or output complement (Q′ output). If the Q output does not also serve as a scan output, there may also be a dedicated scan output pin.

In one or more examples, an MBFF of a FlexMBFF family may include one or more bit-slice blocks. In one example, a bit-slice block can be removed from an existing instance of a 2-bit MBFF of a FlexMBFF family to create a 1-bit MBFF of the FlexMBFF family that includes the control block and the remaining bit-slice block. In another example, a pre-built single-bit flip-flop can be converted into a 1-bit MBFF of a FlexMBFF family. In various embodiments, a designer can add additional bit-slice blocks to a 1-bit MBFF (e.g., to create a 2-bit MBFF), use the 1-bit MBFF instance as a basis for a FlexMBFF family with any number of bits, or keep the 1-bit MBFF in the circuit layout. Accordingly, a MBFF can include one or more bits and the number of bits included in a MBFF may vary as the design progresses through different stages of the chip design flow.

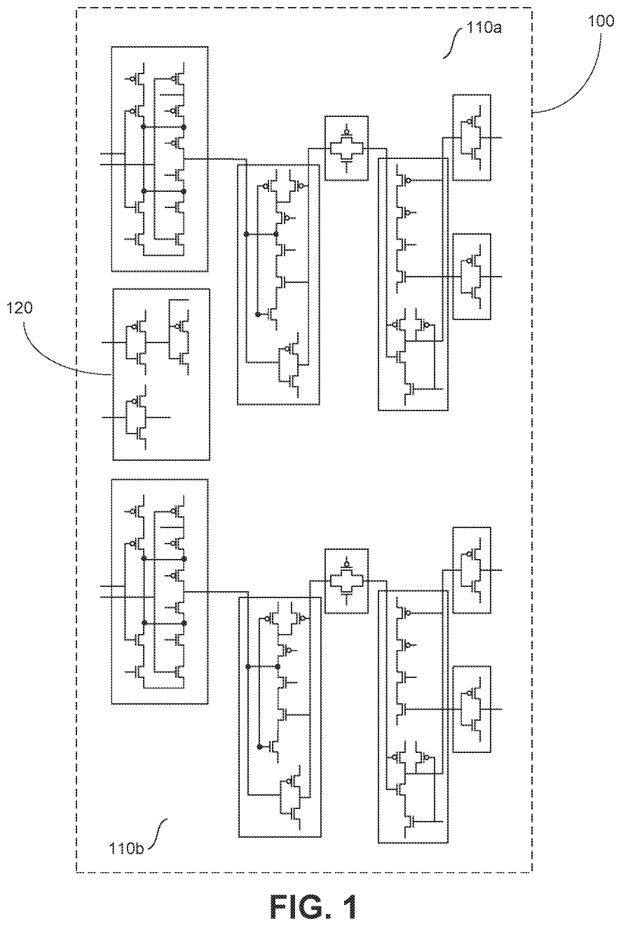

FIG. 1 illustrates a MBFF 100 with a first single-bit flip-flop 110a and a second single-bit flip-flop 110b, and control block 120. The MBFF 100 is an MBFF of a FlexMBFF family. Each of the single-bit flip-flops 110a, 110b includes various flip-flop components (e.g., transistors and other circuit elements). The flip-flop components may be used, for example, to store a bit in memory, clear the memory, read the bit out of memory, etc.

The MBFF 100 includes a control block 120 that generates and drives the shared signals (e.g., CK, SE) for the flip-flops for the first and second single-bit flip-flops 110a, 110b. These signals generated by the control block 120 can include at least one: of clock signals (e.g., CK and CK′), set or reset signals, and scan enable signals, or the like depending on the type of flip-flops being driven.

An MBFF instance of a specified bit-count may be custom designed by selecting each flip-flop bit independently from the other flip-flop bits, selecting a control block of desired characteristics (e.g., implemented with specified VT transistors and specified drive strength to achieve target performance for the flip-flop bits in the MBFF instance). The MBFF instance layout may be assembled by allowing snapping (e.g., tiling) of the selected control block and flip-flop bit-slice blocks such that connections to all flip-flop bits from the control block can be made with compact and predictable routes such as straight-line connections.

In one or more examples, an instance refers to a single software-based representation of a real-world item. Accordingly, a MBFF in a FlexMBFF family, if present multiple times in a circuit layout, will be represented in a software layout tool by a corresponding number of instances. Each MBFF instance within a FlexMBFF family refers to a given set of characteristics, but not necessarily the same layout. For example, a first software representation of an MBFF of a FlexMBFF family with characteristic set X and a second software representation of an MBFF of a FlexMBFF family with characteristic set X but with a different relative arrangement of the bit-slice blocks or flip-flop components, can be considered two instances of one MBFF of a FlexMBFF family. In contrast, if a first software representation of an MBFF of a FlexMBFF family includes a different quantity of bit-slice blocks, a different VT, a different transistor drive strength, or different flip-flop components (e.g., different transistor types or flip-flop types) from a second software representation of an MBFF of the FlexMBFF family, the software representations are two instances; one of a first MBFF of a FlexMBFF family and one of a second MBFF of the FlexMBFF family.

Connections internal to the MBFF instance of a FlexMBFF family may include connections for an SE′ node, CK node, and CK′ node from the control block to the bit-slice blocks, plus connections for set, and reset signals which may be primary inputs to the flip-flop bits. In one or more examples, one may have additional signals such as shifted CK/CK′ for useful skew. In one or more examples, conditional clock signals for scan enable may be implemented.

Global signals may be routed at a design level, as is the case with pre-built MBFFs. For non-stitched MBFFs (e.g., MBFFs without control signals routed internally between flip-flop bits), all scan-in and scan-out connections may remain global. Other global connections may include set/reset inputs to the MBFF, CK input to the MBFF, as well as D input and Q output of each flip-flop bit. In various embodiments, mixed scan out mechanisms may be supported so that incoming and internal flip-flop bits have a shared scan out and outgoing flip-flop bits have dedicated scan outs. For internally scan-stitched MBFFs, the scan may be stitched between successive bits, with scan in to the first flip-flop bit and scan out from the last flip-flop bit being global connections. This stitching may be done after placing all bit-slice blocks and the control block of the MBFF, with a chip level router, a pattern-must-join (PMJ) style pattern routing, or by abutment. Using PMJ style pattern routing and abutment may be possible with careful layout of the control block and flip-flop bit-slices to enable such connections.

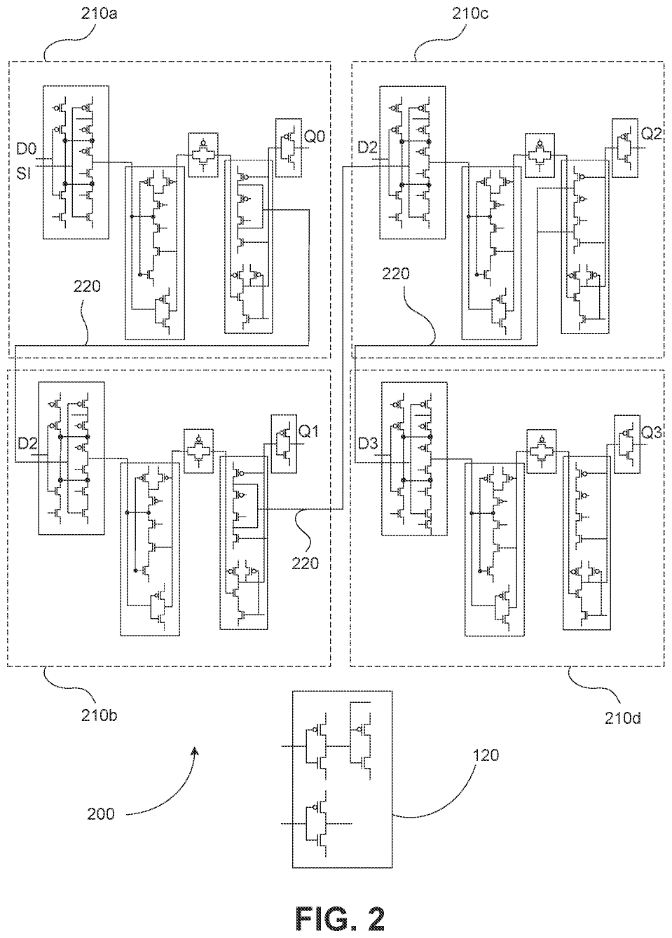

FIG. 2 illustrates a schematic of 4-bit positive edge triggered scan D-flip-flops having stitched scan-in, and Q-only output (e.g., a flip-flop without Q′ output), according to examples of the present disclosure. As shown, flip-flop components may be grouped into a first flip-flop bit 210a, a second flip-flop bit 210b, a third flip-flop bit 210c, and a fourth flip-flop bit 210d to provide a 4-bit MBFF 200. The MBFF 200 is part of a FlexMBFF family. In other examples, more than or fewer than four flip-flop bits can be included in one MBFF. A shared control block 120 is included that manages the shared signals for flip-flop components across the various flip-flop bits, but the scan input (SI) signal is carried via a stitched connection 220 from the output of the first flip-flop bit 210a to the input of the second flip-flop bit 210b, from the output of the second flip-flop bit 210b to the input of the third flip-flop bit 210c, and from the output of the third flip-flop bit 210c to the input of the fourth flip-flop bit 210d. Accordingly, the flip-flop bits in a MBFF of a FlexMBFF family may be independently operated from one another (e.g., as in FIG. 1) or stitched together to chain the operation of one flip-flop bit to the operation of another flip-flop bit in the MBFF (e.g., as in FIG. 2).

When tiling FF bit-slice blocks and a control block to build an MBFF in the FlexMBFF family, shared pins may be aligned to enable predictable connections. For example, with straight routes on an upper metal layer, vias may be used for connection to pins on a lower layer, or pins located on the lower layers may be aligned such that they are collinear when tiled, allowing connection of the pins on the upper and lower layers by extending the pins. Horizontal and/or vertical spines may be implemented in the MBFF bit-slice blocks and the FlexMBFF control block to be used during placement to facilitate alignment of pins.

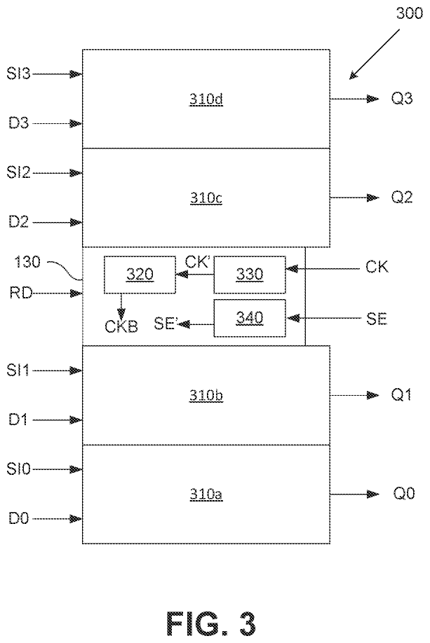

FIG. 3 illustrates a MBFF 300, according to embodiments of the present disclosure. The MBFF 300 is an MBFF of a FlexMBFF family. The MBFF 300 includes a control block 130 for receiving and manipulating shared signals before providing those signals internally to the various flip-flop bits 310a-d. For example, the control block 130 receives all of the reset data RD signal, CK signal, and SE signal, and processes those signals via the CK′-to-CKB inverter 320, the SE-to-SE′ inverter 340, and the CK-to-CK′ inverter 330 in a consolidated location. In turn, the various flip-flop bits 310a-d included in the MBFF 300 are bit-slice blocks that include internal components for storing, retrieving, and clearing a value for a bit in memory. Additionally, the bit-slice blocks include traces or input/output paths to receive the shared signals from the control block 130 or another bit-slice block and to provide those shared signals to another bit-slice block. Each of the flip-flop bits 310a-310d receives a respective data signal (e.g., D0-D3), and a scan data input signal SI (e.g., SI0-SI3). Further, each of the flip-flop bits 310a-310d outputs a respective output signal Q (e.g., Q0-Q3).

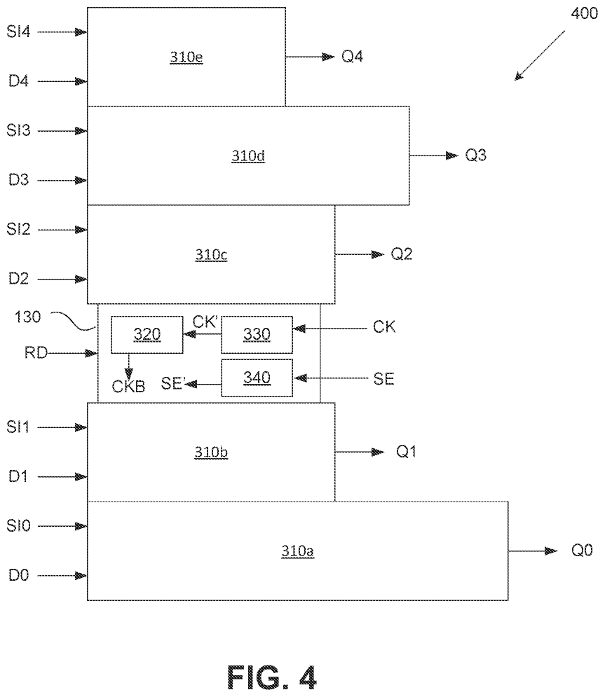

FIG. 4 illustrates an example 5-bit multi-VT mixed drive strength MBFF 400, according to embodiments of the present disclosure. In one example, the MBFF 400 is a FlexMBFF. In the multi-VT mixed drive strength MBFF 400, each of the flip-flop bits 310a-e (and the respective components thereof) may use the same or a different voltage threshold (VT) and/or drive strength from the other flip-flop bits 310a-e, while still using a shared control block 130 for handling shared signals across the flip-flop bits 310a-e. For example, the control block 130 receives the RD, CK, and SE signals, and processes those signals via the CK′-to-CKB inverter 320, the SE-to-SE′ inverter 340, and the CK-to-CK′ inverter 330 in a consolidated location before providing those signals to the flip-flop bits 310a-e. The RD input pin of the control (e.g., common control) block also serves as an output that is connected to the flip-flop bits. In this way the RD input pin is an interconnect trace that is meant to connect directly to the RD input pin of the flip-flop bits. Each of the flip-flop bits 310a-e can be set to a given drive strength or VT independently of how the other flip-flop bits 310a-e are set. Accordingly, the second flip-flop bit 310b and the third flip-flop bit 310c may have identical values set for drive strength and VT, and the first flip-flop bit 310a, fourth flip-flop bit 310d, and fifth flip-flop bit 310e may have unique values for drive strength and VT. Each of the flip-flop bits 310a-310e receives a respective data signal (e.g., D0-D4), and a scan data input signal SI (e.g., SI0-SI4). Further, each of the flip-flop bits 310a-310e outputs a respective output signal Q (e.g., Q0-Q4).

In one or more examples, a MBFF of a FlexMBFF family is characterized using one or more models. The models are used to represent the timing and power characteristics of a flip-flop bit for the MBFFs in the FlexMBFF family. The models may be used in a characterization process to provide on-demand derivation of the model of any MBFF in a corresponding FlexMBFF family. The characterization process using the models described herein is less computational complex as compared to a characterization process that enumerates the models for all possible MBFFs.

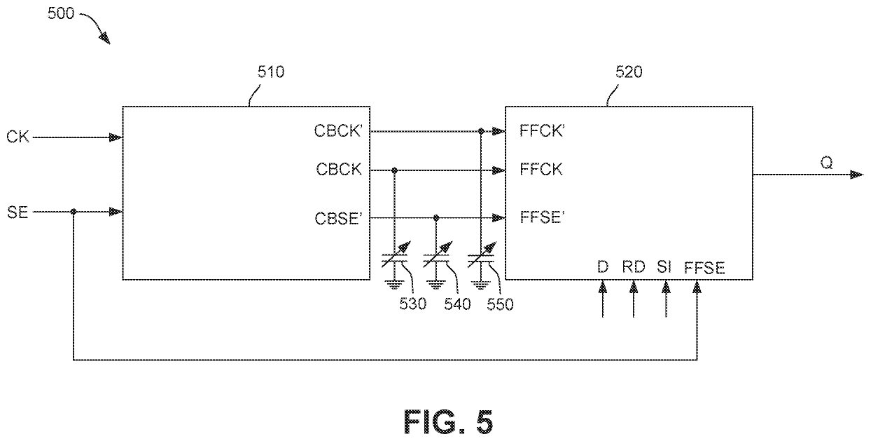

FIG. 5 illustrates a characterization model 500, according to one or more examples. The characterization model 500 includes a control (or common) block 510 and flip-flop bit 520. Further, the characterization model 500 includes variable capacitances 530, 540, and 550.

The characterization model 500 represents the behavior of a flip-flop bit when driven by a specified common control block. In one example, the behavior of the flip-flop bit 520 when driven by the control block 510 is modeled for the different loads driven by the control block 510. The different loads correspond to other flip-flop bits connected to and driven by the control block 510. The loads are represented by values of the variable capacitances 530, 540, and 550. In one or more examples, during a characterization process, the characterization model 500 generates a custom MBFF in the FlexMBFF family by composing the MBFF flip-flop bit by flip-flop bit. The corresponding characterization process generates one or more models. In one example, a model for each unique combination of flip-flop bit and control block in a FlexMBFF family is generated. The total number of models generated is equal to Nff*Nccb. Nff is the number of unique flip-flop bits, and Nccb is the number of unique control blocks in a FlexMBFF family. For a control block having the signals CBCK′ (inverted control block clock signal), CBCK (a non-inverted control block clock signal), and CBSE′ (inverted scan-enable signal) as outputs, the model of the CK pin to Q pin timing arc of a flip-flop bit is defined with reference to the CK pin of the control block, instead of a CBCK input pin of the control block. In one example, the CK pin to Q pin timing arc (e.g., delay or output slew rate) is a function of four indices. The four indices include CK slew rate, Q load, CBCK′ load, and CBCK load. CK slew rate is the input slew at the CK pin of the control block. The Q load is the load at the Q output of the flip-flop bit. The CBCK′ load is the load of the pins that the CBCK′ load is connected to in all other flip-flop bits in the corresponding MBFF on the CBCK′ pin of the control block, and is represented as variable capacitance 550. The CBCK load is the load of the pins the CBCK load is connected to in all other flip-flop bits in the corresponding MBFF on the CBCK pin, and is represented as variable capacitance 530. The CBSE′ load is the load of all other flip-flop bits in the corresponding MBFF on the CBSE′ pin, and is represented by the variable capacitance 540. In one or more examples, the load of the CK pin of the flip-flop bit and of the second clock inverter in the common control block are not included as the load of the CK pin of the flip-flop bit are part of the simulation setup for the characterization process. The CBCK load is the load of the pins the CBCK load is connected to in all of flip-flop bits on the CBCK pin of the control block. The load of the CK pin of the flip-flop bit is not included as the load of the CK pin is part of the simulation setup for characterization.

In one example, a set of load capacitances (e.g., capacitance values) for variable capacitances 530, 540, and 550 are selected for simulation. The selected set of load capacitances includes a range of capacitances values for each of the variable capacitances 530, 540, and 550. The capacitance values are swept through to simulate the performance of the flip-flop bit 520. In one example, the capacitances are swept through from a minimum capacitance value to a maximum capacitance value. In other examples, the capacitance values may be swept in other directions. The selected set of load capacitances act as placeholders, and may be replaced the wire and input pin capacitance (e.g., load capacitance) of a flip-flop bit when the flip-flop bit is part of the MBFF instance of the corresponding FlexMBFF. The load capacitances of the flip-flop bit may be used to extract the timing and/or power behavior of the corresponding flip-flop bit.

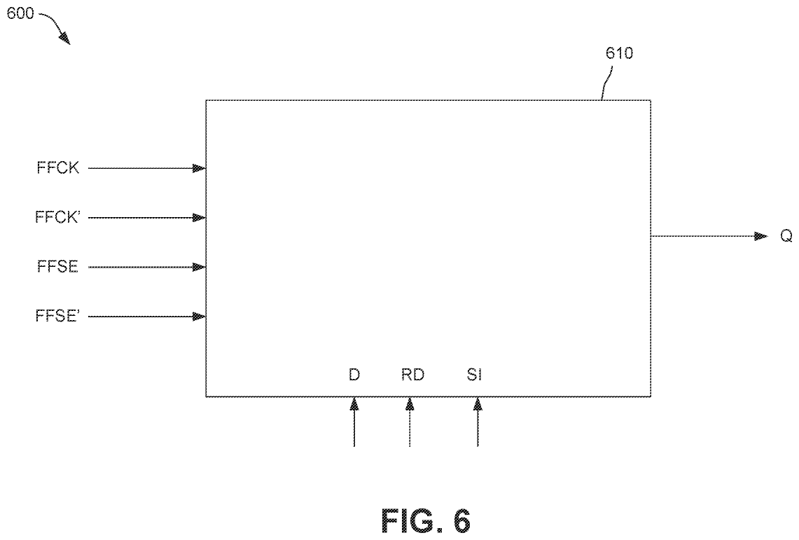

FIG. 6 illustrates a characterization model 600, according to one or more examples. The characterization model 600 includes a flip-flop bit 610. The characterization model 600 represents a flip-flop bit (e.g., flip-flop bit 610) regardless to the corresponding control block that is driving the flip-flop bit. Accordingly, there is only one model per flip-flop bit, compared to k models per flip-flop bit, where k is the number of common control blocks with which a flip-flop bit can be paired. In one or more examples, the characterization of the characterization model 600 is more efficient as compared to other characterization processes as there are fewer characterization models to characterize. Further, in an example where a new control block is added to a FlexMBFF family, no additional characterization is performed. In one or more examples, for a flip-flop bit that receives an FFCK′ (an inverted clock signal), FFCK (a non-inverted clock signal), and FFSE′ (an inverted scan-enable signal) as inputs, the characterization model of the CK→Q delay timing arc of the flip-flop relative to the corresponding CK pin is defined based on the FFCK slew rate, Q load, FFCK′ slew rate, and the FFCK skew.

In one example, the CK pin to Q pin delay timing arc of a flip-flop bit is defined with reference to the corresponding FFCK input pin. The timing (e.g., delay or output slew) of the flip-flop it is a function of the indices including: FFCK slew, Q load, FFCK′ slew, and FFCK skew. FFCK slew is the input slew at the FFCK clock input of the corresponding flip-flop bit. The Q load is the output load at the Q output of the flip-flop bit. The FFCK′ slew rate is the input slew at the FFCK′ inverted clock input pin of the FF bit. The FFCK skew is the delay in arrival time of the clock signal FFCK at the FFCK pin relative to the inverted clock signal FFCK′ at the FFCK′ pin.

In one example, a set of values associated with FFCK and FFCK′ input slews, a set of values associated with the skew between FFCK and FFCK′ arrival times, and/or a set of values associated with the load on Q pin of the flip-flop bit are selected for simulation. In one example, each selected set includes a corresponding range of values. The values in each selected set are swept through to simulate the performance of the flip-flop bit 610. In one example, the values are swept through from a minimum value to a maximum value. In other examples, the values may be swept in other directions. The selected set of values may act as placeholders, and may be replaced by measured values.

In one or more examples, the characterization model 500 and the characterization model 600 are used via repeated invocations of a single bit flip-flop characterization setup that is adapted to characterize the flip-flop bit for the timing arc under characterization in the presence of fixed values of the input values. The values of the other inputs are swept for all possible values of the input values, resulting in a characterization model. The characterization model is a four-dimensional (4D) characterization model.

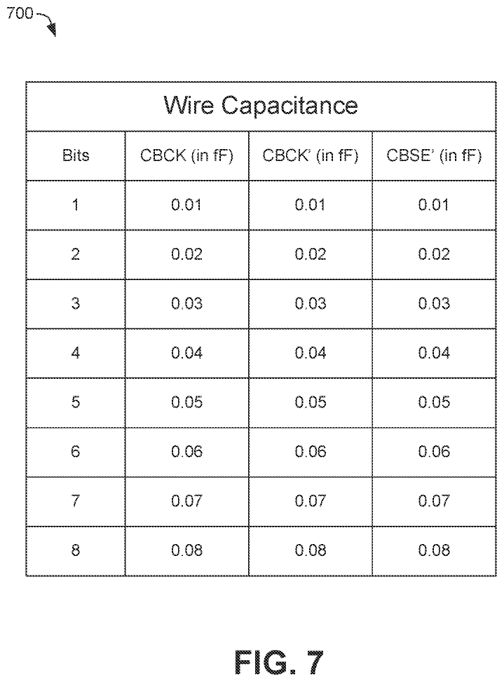

FIG. 7 illustrates a table 700 for flip-flop bits 1-8 of an MBFF of a FlexMBFF family. The table 700 relates the number of bits to a corresponding wire capacitance (e.g., capacitance load) on pins CBCK, CBCK′, and CBSE′ in femto farads (fF) of the flip-flop bits of an MBFF. As can be seen from the table 700, the wire capacitance increases as the number of bits of an MBFF of a FlexMBFF increases.

With further reference to FIG. 5, the characterization model 500 represents the behavior of the flip-flop bit 520 driven by the control block 510, and combination of other bits within the corresponding MBFF. In one example, the flip-flop bit 520 is characterized for the control block 510, and all loads driven by the control block 510. The loads correspond to the wires connecting other flip-flop bit(s) to the corresponding MBFF, and loads of the other flip-flop bits. The flip-flop bit loads include the input pin capacitance of the flip flop bits. In one example, the loads associated with the other flip-flop bits and wires connecting them are represented by the variable capacitances 530, 540, and 550 on the CBCK′ pins, CBCK pins, and CBSE′ pins, as illustrated by FIG. 5.

In one example, the characterization model 500 includes characterizing timing arcs for a single bit of the multi-bit flip-flop in a flexMBFF family (e.g., the flip-flop bit 520) driven by the control block 510. One or more tables are generated by the characterization model 500 during a characterization process. Each table includes at least one index. For example, a first table has one index, which is the input slew rate of the D, RD, SI, and/or FFSE pins of the flip-flop bit 520, and/or CK pin of the control block 510 driving the flip-flop bit 520. A second table has two indices. The indices of the second table are an input slew rate of the RD pin of the flip-flop bit 520, and the load on the Q pin of the flip-flop bit 520. A third table has two indices. The indices of the third table include an input slew rate of the RD and/or FFSE pin of the flip-flop bit 520 and an input slew rate of the CK pin of the control block 510. A fourth table includes three indices. The three indices include an input slew rate of a CK pin of the control block 510, a load on a CBCK pin of the control block 510, and a load on a CBCK′ pin of the control block 510. The four indices of the fifth table include an input slew rate of the D pin, SI pin, RD pin, and/or FFSE pin of the flip-flop bit 520, input slew rate of the CK pin of the control block 510, load on the CBCK pin of the control block 510, and the load on the CBCK′ pin of the control block 510. The sixth table includes four indices. In one example, the indices of the sixth table include an input slew rate of the CK pin of the control block 510, a load on the Q pin of the flip-flop bit 520, the load on the CBCK pin of the control block 510, and the load on the CBCK′ pin of the control block 510. A seventh table has two indices. The indices of the seventh table include an input slew rate at the FFSE pin of the flip-flop bit 520, and a load on the CBSE′ pin of the control block 510.

In one or more examples, the loads on the CBSE′ pin, the CBCK′ pin, and the CBCK pin are passive or active loads of the flip-flop bit under characterization. The total input capacitance of the other flip-flop bits in the MBFF is small as compared to the maximum load index in a typical stand-along cell in a cell library. Thus, the small maximum load values of the CBCK, CBCK′ and CBSE′ pins allow for the reduction of the total number of points from the typical seven points for load values of the Q pin of the flip-flop under characterization to three to five points for the corresponding indices.

In one or more examples, the tables and corresponding values of the different indices are used to determine timing and power characteristics for a control block (e.g., the control block 510) and a flip-flop bit (e.g., flip-flop bit 520) configuration. In one example, a timing delay between the CK pin of the control block 510 and the Q pin of the flip-flop bit 520 (e.g., a transition timing arc between the control block 510 and the flip-flop bit 520) is determined with reference to the CK input of the control block 510. The timing delay between the CK pin of the control block 510 and Q pin of the flip-flop bit 520 is a function of the four indices of the sixth table (e.g., an input slew rate of the CK pin of the control block 510, a load on the Q pin of the flip-flop bit 520, the load on the CBCK pin of the control block 510, and the load on the CBCK′ pin of the control block 510). In one example, a timing delay between the RD pin of the flip-flop bit 520 and the Q output pin of the flip-flop bit 520 (e.g., a transition timing arc of the control block 510 and the flip-flop bit 520) is measured with reference to the RD pin of the flip-flop bit 520. Further, the timing delay between the RD pin of the flip-flop bit 520 and the Q output pin of the flip-flop bit 520 is a determined based on the indices of the second table (e.g., an input slew rate of the RD pin of the flip-flop bit 520, and the load on the Q pin of the flip-flop bit 520). In one example, a setup (hold) timing constraint arc for the data and/or scan enable pins of the control block 510 and the flip-flop bit 520 is determined based on the CK pin of the control block 510. The timing constraint arc is determined based on the indices of the fifth table (e.g., an input slew rate of the D pin, SI pin, RD pin and/or FFSE pin of the flip-flop bit 520, input slew rate of the CK pin of the control block 510, load on the CBCK pin of the control block 510, and the load on the CBCK′ pin of the control block 510). In one example, the recovery (or removal) timing constraint arc of asynchronous pins of the flip-flop bit 520 is determined with reference to the CK pin of the control block 510. The recovery timing constraint arc is determined based on the indices of the fifth table (e.g., an input slew rate of the D pin, SI pin, RD pin and/or FFSE pin of the flip-flop bit 520, input slew rate of the CK pin of the control block 510, load on the CBCK pin of the control block 510, and the load on the CBCK′ pin of the control block 510). In one example, an internal power (hidden) arcs for the D pin, SI pin, and/or RD pin of the flip-flop bit 520 are determined with reference to the respective pin. The internal power arcs are determined based on the indices of table one (e.g., the input slew rate of the D pin, RD pin, SI pin, and/or FFSE pin of the flip-flop bit 520). In one example, an internal power arc for the CK pin of the control block 510 is determined with reference to the CK pin of the control block 510. The internal power arc of the CK pin of the control block 510 is determined based on the indices of table four (e.g., an input slew rate of a CK pin of the control block 510, a load on a CBCK pin of the control block 510, and a load on a CBCK′ pin of the control block 510). In one example, an internal power (hidden) arc for the SE pin of the control block 510 and the flip-flop bit 520 is determined with reference to the respective SE pin. In one example, the internal power arc of the SE pin is a function of the indices of the seventh table (e.g., an input slew rate at the FFSE pin of the flip-flop bit 520, and a load on the CBSE′ pin of the control block 510). In one example, internal power (switching) arcs for the Q pin of the flip-flop bit 520 is determined with reference to the CK pin of the control block 510. The internal power arcs are a function of the indices of the sixth table (e.g., an input slew rate of the CK pin of the control block 510, a load on the Q pin of the flip-flop bit 520, the load on the CBCK pin of the control block 510, and the load on the CBCK′ pin of the control block 510). In one example, the minimum pulse width constraint arc for the clock pin of the flip-flop bit 520 is determined with reference to the CK pin of the control block 510. For example, the minimum pulse width constraint arc is determined as a function of the indices of the fourth table (e.g., an input slew rate of a CK pin of the control block 510, a load on a CBCK pin of the control block 510, and a load on a CBCK′ pin of the control block 510).

With further reference to FIG. 6, the characterization model 600 may be used to model a flip-flop bit (the flip-flop bit 610) regardless of the control block that drives the flip-flop bit. In one example, during a characterization process of a circuit design, the number of models to characterize corresponds to the number of unique flip-flop bits within the circuit design. In one or more examples, the flip-flop bit 610 has input pins FFCK, FFCK′, FFSE, FFSE′, D, RD, and SI, and the output pin Q.

As compared to conventional single-bit flip-flop cells which have a single clock input pin with internal inverters to derive clock and complement clock signals, the flip-flop bit 610 has two clock inputs FFCK for clock and FFCK′ for complement clock which are opposite in phase. Further, as compared to conventional single bit flip-flop cells, the reference clock(s) for the timing arcs is (are) determined relative to the FFCK pin. In one or more examples, the slew rate of the clocks signals FFCK and FFCK′ received at the respective FFCK and FFCK′ pins, and the skew between the clock signals FFCK and FFCK′ contribute to the characteristics of the corresponding circuit design. Accordingly, when characterizing (and modeling) the circuit design and the corresponding flip-flop bits, the slew rate and skew are taken into account. The slew rate of the FFCK′ signal and the skew between the FFCK and FFCK′ signal are modeled as indices within the following tables used during characterization of the circuit design in examples using the flip-flop bit 610. During characterization (modeling) one or more modeling tables are used. Each table includes at least one index.

A first table has one index, which is the input slew rate of the D pin, RD pin, SI pin, FFSE pin, FFCK pin and/or FFCK′ pin of the flip-flop bit 610. A second table has two indices. The indices of the second table are an input slew rate of the RD pin of the flip-flop bit 610, and the load on the Q pin of the flip-flop bit 610. A fourth table includes four indices. The four indices include an input slew rate of the FFCK pin of the flip-flop bit 610, a load on a Q pin of the flip-flop bit 610, and a load on a FFCK′ pin of the flip-flop bit 610. The indices of the fourth table may further include a difference in arrival time between the FFCK and FFCK′ signals. A fifth table has four indices. The four indices of the fifth table include an input slew rate of the D pin, SI pin, RD pin and/or FFSE pin of the flip-flop bit 610, input slew rate of the FFCK pin of the flip-flop bit 610, input slew of the FFCK′ pin of the flip-flop bit 610, and the difference in arrival time between the FFCK and FFCK′ signals. The sixth table includes three indices. In one example, the indices of the sixth table include an input slew rate of the FFCK pin of the flip-flop bit 610, input slew rate of the FFCK′ pin, and a difference in arrival time between the FFCK and FFCK′ signals. A seventh table has three indices. The indices of the seventh table include an input slew rate at the FFSE pin of the flip-flop bit 610, an input slew rate at the FFSE′ pin of the flip-flop bit 610, and a difference in arrival time between the FFSE and FFSE′ signals. In the above, the arrival time of FFCK is later than the arrival time of FFCK′.

The delay (transition) timing arc between the FFCK pin and the Q pin of the flip-flop bit 610 is determined with reference to the FFCK pin. The delay (transition) timing arc is determined based on the indices of the fourth table (e.g., an input slew rate of the FFCK pin of the flip-flop bit 610, a load on a Q pin of the flip-flop bit 610, and a load on a FFCK′ pin of the flip-flop bit 610, and a difference in arrival time between the FFCK and FFCK′ signals). The delay (transition) timing arc between the RD pin and Q pin of the flip-flop bit 610 is determined with reference to the RD pin. The delay timing arc is determined as a function of the indices of the second table (e.g., an input slew rate of the RD pin of the flip-flop bit 610, and the load on the Q pin of the flip-flop bit 610). The setup (hold) timing constraint arc for the data and/or enable pins of the flip-flop bit 610 are defined with reference to the FFCK pin of the flip-flop bit 610. The setup (hold) timing constraint arc is a function of the indices of the fifth table (e.g., an input slew rate of the D pin, SI pin, RD pin and/or FFSE pin of the flip-flop bit 610, input slew rate of the FFCK pin of the flip-flop bit 610, input slew of the FFCK′ pin of the flip-flop bit 610, and the difference in arrival time between the FFCK and FFCK′ signals). The recovery (removal) timing constraint arc for asynchronous pin of the flip-flop bit 610 is defined with reference to the FFCK pin of the flip-flop bit 610. The recovery timing constraint is a function of the indices of the fifth table (e.g., an input slew rate of the D pin, SI pin, RD pin and/or FFSE pin of the flip-flop bit 610, input slew rate of the FFCK pin of the flip-flop bit 610, input slew of the FFCK′ pin of the flip-flop bit 610, and the difference in arrival time between the FFCK and FFCK′ signals). The internal power (hidden) arcs for the D pin, the SI pin, and/or RD pin are measured with reference to the respective pin. The internal power arcs are determined based on a function of the indices of the first table (e.g., slew rate of the D pin, RD pin, SI pin, FFSE pin, FFCK pin and/or FFCK′ pin of the flip-flop bit 610). In one example, the internal power (hidden) arcs for the FFCK pin of the flip-flop bit 610 is measured with reference to the FFCK pin. The internal power arc is a function of the indices of the sixth table (an input slew rate of the FFCK pin of the flip-flop bit 610, input slew rate of the FFCK′ pin, and a difference in arrival time between the FFCK and FFCK′ signals). In one example, the internal power arcs for the FFSE pin of the flip-flop bit 610 is measured with reference to the FFSE pin. The internal power arc is determined as a function of the indices of the seventh table (e.g., an input slew rate at the SE pin of the flip-flop bit 610, an input slew rate at the SE′ pin of the flip-flop bit 610, and a difference in arrival time between the SE and SE′ signals). The internal power (switching) arc (or arcs) for the Q pin of the flip-flop bit 610 are determined with reference to the Q pin. The internal power arc is determined as a function of the indices of the fourth table (e.g., an input slew rate of the FFCK pin of the flip-flop bit 610, a load on a Q pin of the flip-flop bit 610, and a load on a FFCK′ pin of the flip-flop bit 610, and a difference in arrival time between the FFCK and FFCK′ signals. A fifth table has four indices). The minimum pulse width constraint for the clock pin (e.g., the FFCK pin and/or the FFCK′ pin) of the flip-flop bit 610 is determined with reference to the FFCK and FFCK′ pins. The minimum pulse width constraint for the clock pin is determined as a function of the indices of the sixth table (e.g., an input slew rate of the FFCK pin of the flip-flop bit 610, input slew rate of the FFCK′ pin, and a difference in arrival time between the FFCK and FFCK′ signals).

The use of the characterization model 600 allows for a conventional single bit flip-flop to be resembled with a difference of two clock signals in opposite phase (e.g., clock signals FFCK and FFCK′) as compared to a single clock signal. Accordingly, the difference is accounted for by including the slew rate and skew between the clock signals as indices used within the tables during modeling.

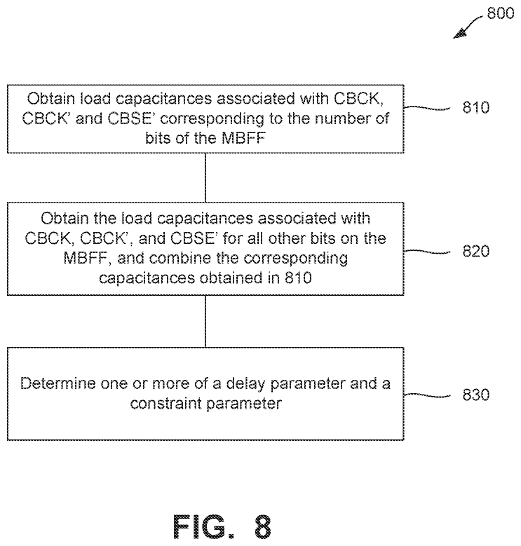

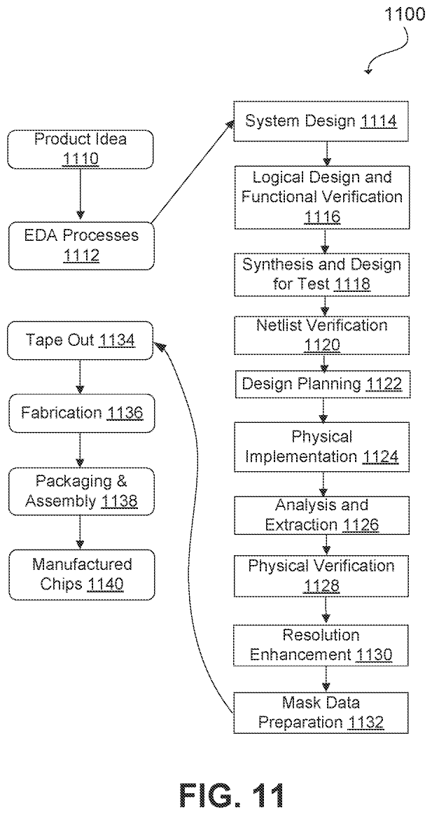

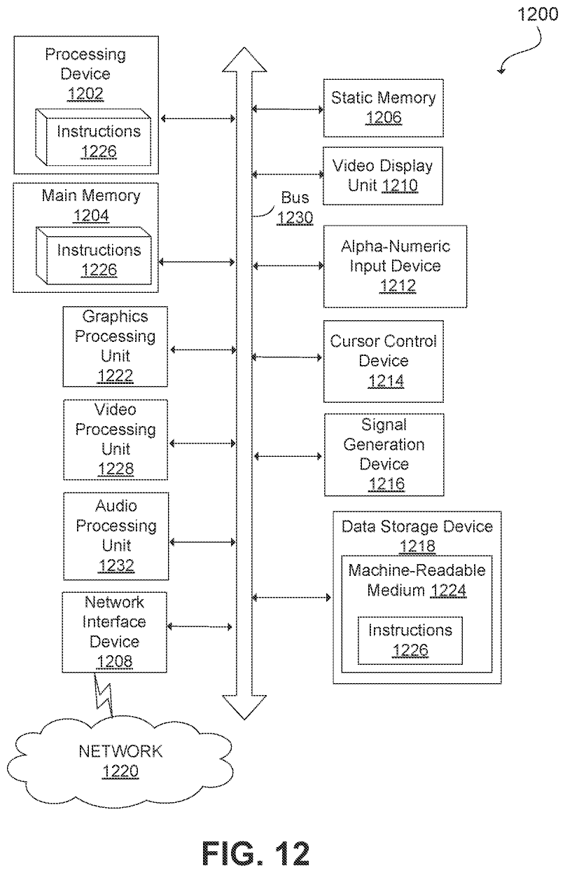

FIG. 8 illustrates a flowchart of a method 800 for determining a timing model for delay and constraint for an MBFF of a FlexMBFF family, according to one or more examples. The method 800 is used to generate a model for each flip-flop bit and control block pair. In one example, the method 800 is performed by the computer system 1200 of FIG. 12. In such an example, the computer system is, or is part of, of a compiler system or a circuit layout system. In one example, a processing device (e.g., the processing device 1202 of FIG. 12) executes instructions (e.g., the instructions 1226 of FIG. 12) stored in a memory (e.g., main memory 1204 or the machine-readable medium 1224 of FIG. 12) to perform the method 800. In one example, the method 800 is performed as part of the process analysis and extraction 1126 of FIG. 11. In one example, the method 800 is performed for each flip-flop bit within an MBFF.

At 810, the load capacitances of CBCK, CBCK′, and CBSE′ corresponding to the number of bits of the MBFF are obtained. The load capacitance corresponds to the wire capacitance coupling between each other flip-flop bit and/or the input pin capacitance of each other flip-flop bit. For example, with reference to FIG. 5, the capacitance values of the variable capacitances 530, 540, and 550 are set based on the number of bits of the MBFF. In one example, the capacitance values are obtained from a table (e.g., or another representation). FIG. 7 illustrates an example table 700 that indicates the capacitance values of the variable capacitances 530, 540, and 550 for a number of flip-flop bits 1-8.

At 820, the load capacitances associated with CBCK, CBCK′, and CBSE′ for all other bits in the MBFF are obtained and combined with the capacitances obtained in 810. For example, with reference to FIG. 5, the capacitance values of the variable capacitances 530, 540, and 550 for each other bit in the MBFF are obtained as described above with regard to 810 of the method 800, and combined with the capacitances obtained in 810 of the method 800. For example, each load capacitance of associated with CBCK is combined (e.g., summed or combined in another way), each load capacitance associated with CBCK′ is combined (e.g., summed or combined in another way), and each load capacitance associated with CBSE′ is are combined (e.g., summed or combined in another way) to generate a combined (e.g., total) load capacitance for CBCK, CBCK′, and CBSE′ associated with a bit of a MBFF.

At 830, one or more of a delay parameter and constraint parameters are determined. In one or more examples, determining the delay parameter and/or the constraint parameters includes characterizing a corresponding model (e.g., table) as described above with regard to FIG. 5 for the delay parameter and/or the constraint parameters. In one example, a 2D model with indices including input slew rate of the CK pin of a control block (e.g., the control block 510 of FIG. 5) and capacitance load on the Q pin of the flip-flop bit (e.g., the flip-flop bit 520) is characterized to determine a delay parameter. In another example, a 2D model with indices including input slew rate of the CK pin, D pin, SI pin, and FFSE pin of a flip-flop bit (e.g., the flip-flop bit 520) is characterized to determine a constraint parameter. In one example, with reference to FIG. 5, the input slew of the CK pin is determined based on one or more of the combined load capacitance for CBCK, the CBCK′, and SE′ associated with the bit of the MBFF. The input slew on the CK pin and the load capacitance of the Q pin are used to determine the timing model for delay and constraint for a MBFF. In one or more examples, a power model for the MBFF is determined similarly as described above. For example, the input slew of the CK pin, D pin, RD pin, SI pin, and/or the SE pin of the MBFF. The slew of the CK pin, D pin, RD pin, SI pin, and the SE pin are determined based at least in part on the combined load capacitances of CBCK, CBCK′, and CBSE′.

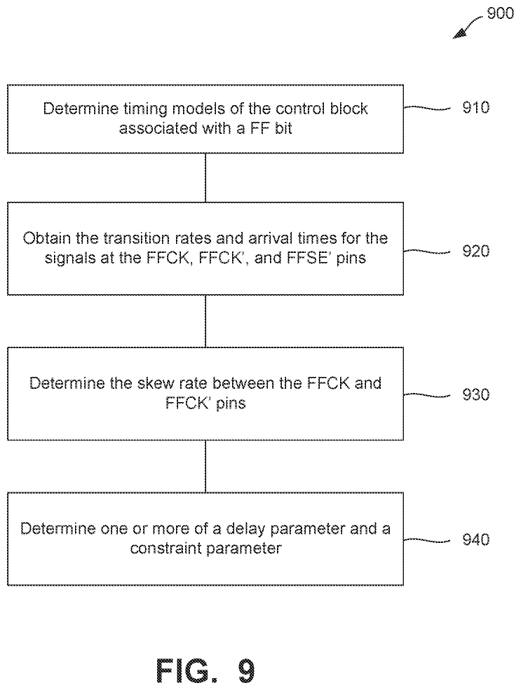

FIG. 9 illustrates a flowchart of a method 900 for determining a timing model for delay and constraint for an MBFF of a FlexMBFF family, according to one or more examples. The method 900 is used to generate a model for each flip-flop bit and control block pair. In one example, the method 900 is performed by the computer system 1200 of FIG. 12. In such an example, the computer system is, or is part of, of a compiler system or a circuit layout system. In one example, a processing device (e.g., the processing device 1202 of FIG. 12) executes instructions (e.g., the instructions 1226 of FIG. 12) stored in a memory (e.g., main memory 1204 or the machine-readable medium 1224 of FIG. 12) to perform the method 900. In one example the method 900 is performed as part of the process analysis and extraction 1126 of FIG. 11. In one example, the method 900 is performed for each flip-flop bit of an MBFF.

At 910, timing models of the control block associated with an FF bit are determined. For example, with reference to FIG. 6, the timing models of the control block that drives signals onto the FFCK, FFCK′, and FFSE′ pins of the flip-flop bit 610 are determined.

At 920, the transition rates and arrival times for the signals at the FFCK, FFCK′ and FFSE′ pins are obtained. The transition rates and arrival times are obtained based on the timing models determined at 910 of the method 900.

At 930, the skew between the FFCK and FFCK′ pins are determined. In one example, with reference to FIG. 6, the skew rate is determined between the FFCK and FFCK′ pins of the flip-flop bit 610 are determined.

At 940, one or more of a delay parameter and constraint parameters are determined. In one or more examples, determining the delay parameter and/or the constraint parameters includes characterizing a corresponding model (e.g., table) as described above with regard to FIG. 6 for the delay parameter and/or the constraint parameters. In one example, the delay parameter of the flip-flop bit (e.g., the flip-flop bit 610 of FIG. 6) is determined based on the transition rates and arrival times of the signals at the FFCK, FFCK′ pins, and the skew rate between the FFCK and FFCK′. The delay parameter is added to the delay of the corresponding control block to determine a delay for the MBFF. In one example, the timing model is determined based on the delay of the flip-flop bit (e.g., the flip-flop bit 610 of FIG. 6). In one example, a constraint parameter of the flip-flop bit is further based on the skew rate between the FFCK and FFCK′ pins and the input slew rate of the D pin, SI pin, and FFSE pin of the FF bit (e.g., the flip-flop bit 610 of FIG. 6).

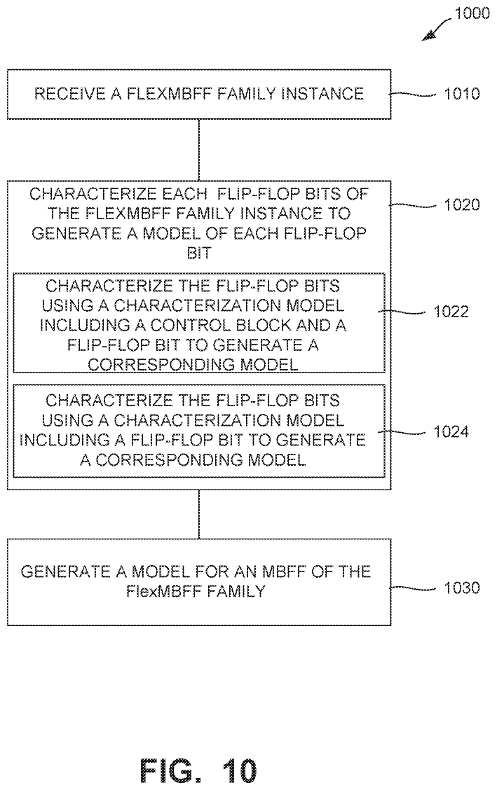

FIG. 10 illustrates a flowchart of a method 1000 for modeling and characterizing an MBFF of a FlexMBFF family, according to one or more examples. In one example, the method 1000 is performed by the computer system 1200 of FIG. 12. In such an example, the computer system is, or is part of, of a compiler system or a circuit layout system. In one example, a processing device (e.g., the processing device 1202 of FIG. 12) executes instructions (e.g., the instructions 1226 of FIG. 12) stored in a memory (e.g., main memory 1204 or the machine-readable medium 1224 of FIG. 12) to perform the method 1000. In one example the method 1000 is performed as part of the process analysis and extraction 1126 of FIG. 11.

At 1010, a FlexMBFF family instance is obtained. For example, the FlexMBFF family instance is obtained by the computer system 1200 of FIG. 12 from a memory (e.g., main memory 1204 or the machine-readable medium 1224 of FIG. 12). The FlexMBFF family instance may be part of a cell library used during the generation of a circuit schematic and layout. A FlexMBFF family instance includes one or more MBFFs. Each MBFF includes one or more flip-flop bit cells (e.g., FF bits) and a control block. In one example, a FlexMBFF family instance includes the MBFF 100 of FIG. 1, the MBFF 200 of FIG. 2, the MBFF 300 of FIG. 3, and/or the MBFF 400 of FIG. 4. The MBFF 100 includes two flip-flop bits (e.g., flip-flops 110a and 110b), the MBFF 200 of FIG. 2 includes four flip-flop bits (e.g., flip-flops 210a-210d), the MBFF 300 of FIG. 3 includes four flip-flop bits (e.g., flip-flops 310a-310d), and the MBFF 400 of FIG. 4 includes five flip-flop bits (e.g., flip-flops 310a-310e). In one or more examples, each of the MBFF 100, 200, 300, and 400 includes a control block (e.g., the control block 130 of FIG. 1, 2, 3, or 4) that drives the control signals for each of the flip-flop bits.

At 1020, the flip-flop bits of a FlexMBFF family instance are characterized. In one example, the computer system 1200 of FIG. 12 characterizes each of the flip-flop bits of a MBFF of a FlexMBFF family instance based on one of the characterization models 500 and 600. In one example, with reference to FIG. 3 and FIG. 5, each of the flip-flops 310a-310d are characterized based on the characterization model 500 (e.g., at 1022). The control block 130 and the flip-flop bit 310a are characterized based on the characterization model 500 to generate a corresponding model with characteristics of the control block 130 and the flip-flop bit 310a. In one example, the flip-flop bits for each control block in the FlexMBFF family is characterized using a characterization model similar to that of the characterization model 500 to generate a model for each flip-flop bit and control block combination. For example, a model or models for each combination of flip-flop bit and control block is generated using a characterization model similar to that of the characterization model 500 (e.g., a characterization model including a flip-flop bit and control block). Characterizing a flip-flop determines the characteristics of the corresponding transistors, and other circuit elements based on the parameters of the characterization model, which are used to determine timing and power parameters of the control block 130 and the flip-flop bit 310a. To characterize the control block 130 and the flip-flop bit 310a based on the characterization model 500, the values of the variable capacitances 530, 540, and 550 are set based on the flip-flop bits 310b-310d (e.g., flip-flop bits) that are additionally driven by the control block 130. In one example, the load of the variable capacitance 530 is the sum of the FFCK pin capacitance of each of the flip-flop bits, the load of the variable capacitance 540 is the sum of the FFCK′ pin capacitance of each of the flip-flop bits, the load of the capacitor 520 is the sum of the FFSE′ pin capacitance of each of the flip-flop bits and respective loads associated with corresponding wire. In one example, if the maximum number of flip-flop bits supported by model is “N”, then the max_load index of the model is equal to the sum of wire capacitance of N bits and (N−1)*MAXFFCK. Where MAXFFCK is the maximum input capacitance across all flip-flop bits in the flexMBFF compiler. In one example, the value of the variable capacitance 540 is largest enough to cover driving of all the flip-flops connected to the flip-flop bit 520. Further, characterizing the control block 130 and the flip-flop bit 310a based on the characterization model 500 includes receiving, or determining or obtaining, the slew rates of the D pin, RD pin, SI pin, SE pin, and CK pin for the control block 130 and the flip-flop bit 310a. In one example, the slew rates are provided by a designer. In another example, the slew rates are determined from the corresponding circuit design.

The tables described above with regard to the characterization model 500 are used during the characterization process to determine a model of the timing parameters of the control block 130 and the flip-flop bit 310a. The timing parameters may be timing delay arcs, timing constraints, internal power arcs, and minimum pulse width constraint arcs between pins of the control block 130 and the flip-flop bit 310a.

In one or more examples, each of the other flip-flop bits (e.g., flip-flop bits 310b-310d of FIG. 3) of the MBFF are characterized and modeled as described above with regard to the flip-flop bit 310a.

In another example, with reference to FIG. 3 and FIG. 6, each of the flip-flops 310a-310d are characterized based on the characterization model 600 (e.g., at 1024). For example, the flip-flop bit 310a is characterized based on the characterization model 600 to generate a corresponding model with characteristics of the flip-flop bit 310a. Characterizing a flip-flop determines the characteristics of the corresponding transistors, and other circuit elements based on the parameters of the characterization model. The timing parameters of the signals corresponding to the FFCK pin, FFCK′ pin, FFSE pin, FFSE′ pin, D pin, RD pin, SI pin, and Q pin are applied to the characterization model 600 to characterize the flip-flop bit 310a. In one example, characterizing the flip-flop bit 310a based on the characterization model 600 includes receiving, or determining or obtaining, the slew rates at the FFCK pin, FFCK′ pin, FFSE pin, FFSE′ pin, D pin, RD pin, and SI pin for the flip-flop bit 310a. In one example, the possible value of the load on the Q pin is also obtained. In one example, the slew rates and load value are provided by a designer. In another example, the slew rates and load value are determined from the corresponding circuit design.

The tables described above with regard to the characterization model 600 are used during the characterization process to determine a model of the timing parameters of the flip-flop bit 310a, to characterize the flip-flop bit 310a. The timing parameters may be timing delay arcs, timing constraints, internal power arcs, and minimum pulse width constraint arcs between pins of the control block 130 and the flip-flop bit 310a. During the characterization process, the various possible values for the slew rates and load value are swept through (e.g., selectively applied) to the characterization model 600 to characterize the flip-flop bit 310a. In one or more examples, each of the other flip-flop bits (e.g., flip-flop bits 310b-310d of FIG. 3) of the MBFF are characterized and modeled as described above with regard to the flip-flop bit 310a.

At 1030, a model of a corresponding MBFF is generated within a FlexMBFF family. In one or more examples, a model is generated for the MBFF based on the models of one or more of the characterized flip-flop bits and a model of the corresponding control block. The model and corresponding flip-flop bit characterization are used to characterize the MBFF. For example, the model for each flip-flop bit in a specified MBFF belonging to the FlexMBFF family is extracted as is described with regard to the method 800 and/or the method 900. The extracted models are combined with the model of the corresponding control block or control blocks to generate a model of the MBFF. In one or more examples, a model for the MBFFs in a FlexMBFF is characterized by simulating circuits (e.g., transistors and other circuit elements) based on operating characteristics (e.g., timing and load characteristics). In one or more examples, a model is generated for the MBFF 300 of FIG. 3 based on the models of the flip-flop bits 310a-310d and the control block 130. The MBFF 300 is characterized using the characterizations of the flip-flop bits 310a-310d. Further, a model is generated for the MBFF 400 of FIG. 4 based on the models of the flip-flop bits 310a-310e and the control block 130. The MBFF 400 is characterized using the characterizations of the flip-flop bits 310a-3103.

In one example, during a circuit layout process, the FlexMBFF family uses the FlexMBFF instance generated as a basis for the layout and selection of the internal elements (e.g., the control components and the flip-flop components). Further, additional components are also included in the family with a plurality of different drive strengths, voltage thresholds, and transistors types. Individual blocks in the family can have different internal constructions to allow a designer to swap out different control blocks or bit-slice blocks for new blocks with the desired drive strengths, voltage threshold, or transistor types. The various additional components provide flexibility in adjusting the operation of the FlexMBFF.

In one or more examples, a circuit design (or circuit layout) system (e.g., the computer system 1200 of FIG. 12) generates a circuit layout from a circuit design using one or more FlexMBFF instances from a library. A FlexMBFF instance includes a control block (e.g., the control block 130 of FIG. 3) that drives one or more flip-flop bits (e.g., flip-flop bits 310a-310d of FIG. 3). The control block and one or more flip-flop bits are cells that are circuit board layout structures with known input/output locations on the perimeters of the cells, allowing the circuit design system to route shared signals between the cells by placing the cells into contact with one other (e.g., tiling the cells) or with predictable routes for signal traces between the cells if not placed into contact with one another. In various embodiments, the shared signal pathways can be routed directly from the control block to the flip-flop blocks or indirectly routed from the control block through one or more intervening flip-flop blocks to the various flip-flop blocks. In one or more examples, the control block is separately peaceable from the flip-flop bit blocks. The separately placeable nature of the control block and the flip-flop bit blocks allows for the ready replacement of individual circuit elements and the potential re-layout of those circuit elements. For example, to make room for another circuit element moved within or added to the layout, the one or more processors can move one or more of the cells for the control block and the flip-flop blocks, and re-route the connections is performed for the moved cell (or cells).

Similarly, because control blocks and flip-flop blocks are separately placeable, they are separately replaceable or adjustable. Because the shared control components are concentrated in the control block, when a designer updates the FlexMBFF by adding or removing a flip-flop cell or replacing an existing flip-flop bit for another with different values (e.g., for VT or drive strength), the one or more processors can adjust the control components in the control block (or replace the existing control block with a different control block) based on the updated characteristics of the FlexMBFF. Accordingly, the designer can increase or decrease the drive strength, VT, and clock skew (among other characteristics) offered by the control block without having to a computationally expensive de-banking/re-banking procedure when creating a customized FlexMBFF. Further, as each flip-flop bit of a FlexMBFF is characterized, and as changes are made to the characteristics of the Flex MBFF, the characterization of the flip-flop bits can be updated accordingly. In one or more examples, a fabrication system uses a circuitry layout including one or more FlexMBFFs to fabricate an integrated circuit from a circuit design based on the emulation versions (e.g., the instances) of those FlexMBFFs.

FIG. 11 illustrates an example set of processes 1100 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 1110 with information supplied by a designer, information which is transformed to create an article of manufacture that uses a set of EDA processes 1112. When the design is finalized, the design is taped-out 1134, which is when artwork (e.g., geometric patterns) for the integrated circuit is sent to a fabrication facility to manufacture the mask set, which is then used to manufacture the integrated circuit. After tape-out, a semiconductor die is fabricated 1136 and packaging and assembly processes 1138 are performed to produce the finished integrated circuit 1140.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 8. The processes described by be enabled by EDA products (or EDA systems).

During system design 1114, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 1116, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 1118, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 1120, the netlist is checked for compliance with timing constraints and for correspondence with the HDL code. During design planning 1122, an overall floor plan for the integrated circuit is constructed and analyzed for timing and top-level routing.

During layout or physical implementation 1124, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 1126, the circuit function is verified at the layout level, which permits refinement of the layout design. During physical verification 1128, the layout design is checked to ensure that manufacturing constraints are correct, such as DRC constraints, electrical constraints, lithographic constraints, and that circuitry function matches the HDL design specification. During resolution enhancement 1130, the geometry of the layout is transformed to improve how the circuit design is manufactured.

During tape-out, data is created to be used (after lithographic enhancements are applied if appropriate) for production of lithography masks. During mask data preparation 1132, the ‘tape-out’ data is used to produce lithography masks that are used to produce finished integrated circuits.

A storage subsystem of a computer system (such as computer system 1200 of FIG. 12) may be used to store the programs and data structures that are used by some or all of the EDA products described herein, and products used for development of cells for the library and for physical and logical design that use the library.

FIG. 12 illustrates an example machine of a computer system 1200 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1200 includes a processing device 1202, a main memory 1204 (e.g., read-only memory (ROM), flash memory, dynamic random access memory (DRAM) such as synchronous DRAM (SDRAM), a static memory 1206 (e.g., flash memory, static random access memory (SRAM), etc.), and a data storage device 1218, which communicate with each other via a bus 1230.

Processing device 1202 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. The processing device 1202 may be configured to execute instructions 1226 for performing the operations and steps described herein.

The computer system 1200 may further include a network interface device 1208 to communicate over the network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), a graphics processing unit 1222, a signal generation device 1216 (e.g., a speaker), graphics processing unit 1222, video processing unit 1228, and audio processing unit 1232.

The data storage device 1218 may include a machine-readable storage medium 1224 (also known as a non-transitory computer-readable medium) on which is stored one or more sets of instructions 1226 or software embodying any one or more of the methodologies or functions described herein. The instructions 1226 may also reside, completely or at least partially, within the main memory 1204 and/or within the processing device 1202 during execution thereof by the computer system 1200, the main memory 1204 and the processing device 1202 also constituting machine-readable storage media.

In some implementations, the instructions 1226 include instructions to implement functionality corresponding to the present disclosure. While the machine-readable storage medium 1224 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1202 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system′s registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In a first example, a non-transitory computer readable medium comprising stored instructions, which when executed by a processor, cause the processor to obtain first load capacitances associated with a first flip-flop bit of a multi-bit flip-flop family coupled with a control block; obtain second load capacitances associated with a second flip-flop bit of the multi-bit flip-flop family coupled with the control block; combining the first load capacitances with the second load capacitances to generate combined load capacitances; and determine at least one selected from the group comprising a delay parameter for the first flip-flop bit and a constraint parameter for the first flip-flop bit based on the combined load capacitance.

The non-transitory computer readable medium of the first example, wherein the at least one selected from the group comprising the delay parameter and the constraint parameter for the first flip-flop bit is further determined based on a slew rate of a input clock signal of the control block.

The non-transitory computer readable medium of the first example, wherein the at least one selected from the group comprising the delay parameter and the constraint parameter for the first flip-flop bit is further determined based on a load capacitance of an output node of the first flip-flop bit.

The non-transitory computer readable medium of the first example, wherein the at least one selected from the group comprising the delay parameter and the constraint parameter for the first flip-flop bit is further determined based on at least one selected from the group comprising a slew rate of a reset signal of the first flip-flop bit, a slew rate of a data signal of the first flip-flop bit, a slew rate of a scan data input signal of the first flip-flop, and a slew rate of a scan-enable signal of the first flip-flop bit.

The non-transitory computer readable medium of the first example, wherein the first load capacitances include a first load capacitance associated with a first pin of the control block, the first load capacitances include a second load capacitance associated with a second pin of the control block, and the first load capacitance include a third load capacitance associated with a third pin of the control block, wherein the control block is configured to output a clock signal via the first pin, an inverted clock signal via the second pin, and a scan enable signal via the third pin.

In a second example, a non-transitory computer readable medium comprising stored instructions, which when executed by a processor, cause the processor to: obtain timing parameters of one or more input pins of a flip-flop bit; obtain transition rates and arrival times associated with the one or more input pins of the flip-flop bit based on the timing parameters; determine a skew rate between two pins of the one or more input pins of the flip-flop bit based on the difference between corresponding arrival times of the two pins; and determine at least one selected from the group comprising a delay parameter and a constraint parameter for the flip-flop bit based on the transition rates, the arrival times, and the skew rate.

The non-transitory computer readable medium of the second example, wherein determining the skew rate between the two pins comprises at least one of determining a slew rate of a clock signal received at first clock pin of the two pins and determining a slew rate of a complement clock signal received at a second clock pin of the two pins.

The non-transitory computer readable medium of the second example, wherein the at least one selected from the group comprising the delay parameter and the constraint parameter is further determined based on an input slew rate of a data pin, an input slew rate of a reset pin, an input slew rate of a scan data input signal, and an input slew rate of a scan enable pin.

The non-transitory computer readable medium of the second example, wherein the at least one selected from the group comprising the delay parameter and the constraint parameter is further determined based on a capacitance load of an output pin.

The non-transitory computer readable medium of the second example wherein the at least one selected from the group comprising the delay parameter and the constraint parameter is further determined based on a capacitive load of a first input pin of the one or more input pins.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
obtaining first load capacitances associated with a first flip-flop bit of a multi-bit flip-flop family coupled with a control block;
obtaining second load capacitances for associated with a second flip-flop bit of the multi-bit flip-flop family coupled with the control block;
combining the first load capacitances with the second load capacitances to generate combined load capacitances; and
determining, by a processing device, at least one selected from the group comprising a delay parameter for the first flip-flop bit and a constraint parameter for the first flip-flop bit based on the combined load capacitance.

2. The method of claim 1, wherein the at least one selected from the group comprising the delay parameter and the constraint parameter for the first flip-flop bit is further determined based on a slew rate of a input clock signal of the control block.

3. The method of claim 1, wherein the at least one selected from the group comprising the delay parameter and the constraint parameter for the first flip-flop bit is further determined based on a load capacitance of an output node of the first flip-flop bit.

4. The method of claim 1, wherein the at least one selected from the group comprising the delay parameter and the constraint parameter for the first flip-flop bit is further determined based on at least one selected from the group comprising a slew rate of a reset signal of the first flip-flop bit, a slew rate of a data signal of the first flip-flop bit, a slew rate of a scan data input signal of the first flip-flop bit, and a slew rate of a scan-enable signal of the first flip-flop bit.

5. The method of claim 1, wherein the first load capacitances include a first load capacitance associated with a first pin of the control block, a second load capacitance associated with a second pin of the control block, and the a third load capacitance associated with a third pin of the control block, wherein the control block is configured to output a clock signal via the first pin, an inverted clock signal via the second pin, and a scan enable signal via the third pin.

6. A method comprising:
determining, via a processing device, a characterization of a first flip-flop bit of a multi-bit flip-flop family based on a characterization model comprising a control block and the first flip-flop bit, wherein outputs of the control block are coupled to inputs of the first flip-flop bit, and wherein determining the characterization of the first flip-flop bit comprises determining at least one selected from a group comprising a delay parameter for the first flip-flop bit and a constraint parameter for the first flip-flop bit based on a load capacitance associated with the first flip-flop bit and a second flip-flop bit of the multi-bit flip-flop family; and
updating a database of flip-flop bit models based on the characterization of the first flip-flop bit.

7. The method of claim 6, wherein updating the database comprises generating a model for the first flip-flop bit and the control block based on the characterization of the first flip-flop bit.

8. The method of claim 6, wherein the load capacitance is based on first load capacitances between the first flip-flop bit and the control block and second load capacitances between the second flip-flop bit of the multi-bit flip-flop family and the control block.

9. The method of claim 6, wherein the at least one selected from the group comprising the delay parameter and the constraint parameter for the first flip-flop bit is further determined based on at least one selected from the group comprising a slew rate of a input clock signal of the control block, a slew rate of a reset signal of the first flip-flop bit, a slew rate of a data signal of the first flip-flop bit, a slew rate of a scan data input signal of the first flip-flop bit, and a slew rate of a scan-enable signal of the first flip-flop bit.

10. The method of claim 6 further comprising:
determining a characterization of the second flip-flop bit of the multi-bit flip-flop family based on a characterization model comprising the control block and the second flip-flop bit, wherein determining the characterization of the second flip-flop bit comprises determining at least one selected from a group comprising a delay parameter and a constraint parameter for the second flip-flop bit based on the load capacitance associated with the second flip-flop bit and the first flip-flop bit of the multi-bit flip-flop family, wherein the database of the flip-flop bit models is updated based on the characterization of the second flip-flop bit.

11. A method comprising:
obtaining timing parameters of one or more input pins of a flip-flop bit;
obtaining transition rates and arrival times associated with the one or more input pins of the flip-flop bit based on the timing parameters;
determining a skew rate between two pins of the one or more input pins of the flip-flop bit based on a difference between corresponding arrival times of the two pins; and
determining at least one selected from the group comprising a delay parameter the flip-flop bit and a constraint parameter for the flip-flop bit based on the transition rates, the arrival times, and the skew rate.

12. The method of claim 11, wherein determining the skew rate between the two pins comprises at least one of determining a slew rate of a clock signal received at first clock pin of the two pins and determining a slew rate of a complement clock signal received at a second clock pin of the two pins.

13. The method of claim 11, wherein the at least one selected from the group comprising the delay parameter and the constraint parameter is further determined based on an input slew rate of a data pin, an input slew rate of a reset pin, an input slew rate of a scan data input signal, and an input slew rate of a scan enable pin.

14. The method of claim 11, wherein the at least one selected from the group comprising the delay parameter and the constraint parameter is further determined based on a capacitance load of an output pin.

15. The method of claim 14, wherein the at least one selected from the group comprising the delay parameter and the constraint parameter is further determined based on a capacitive load of a first input pin of the one or more input pins.

16. A method comprising:
determining, via a processing device, a characterization of a first flip-flop bit based on a characterization model comprising the first flip-flop bit and based on at least one selected from the group comprising a delay parameter the first flip-flop bit and a constraint parameter of the first flip-flop bit; and
updating a database of flip-flop bit models based on the characterization of the first flip-flop bit.

17. The method of claim 16, wherein the at least one selected from the group comprising the delay parameter and the constraint parameter is determined based on transition rates associated with one or more inputs of the first flip-flop bit, arrival times associated with one or more input pins of the first flip-flop bit, and a slew rate of the one or more input pins.

18. The method of claim 17, wherein the transition rates and the arrival times associated with the one or more input pins are determined based on timing parameters of the one or more input pins, and the slew rate is determined based on a difference between corresponding ones of the arrival times associated with one or more input pins.

19. The method of claim 17, wherein the at least one selected from the group comprising the delay parameter and the constraint parameter is further determined based on a capacitance load of an output pin.

20. The method of claim 16 further comprising:
determining a characterization of a second flip-flop bit based on a characterization model comprising the second flip-flop bit and based on at least one selected from the group comprising a delay parameter and a constraint parameter of the second flip-flop bit, wherein the database of the flip-flop bit models is updated based on the characterization of the second flip-flop bit.
